(19) United States
(12) Patent Application Publication
(10) Pub. No.: US 2026/0361028 A1
(43) Pub. Date: Nov. 12, 2026

(54) METHOD AND APPARATUS FOR SECURING DATA COMMUNICATION DEVICES

(71) Applicant: SAMTEC, INC., New Albany, IN (US)

(72) Inventor: Kiyoshi ABE, New Albany, IN (US)

(21) Appl. No.: 19/118,531

(22) PCT Filed: Oct. 6, 2023
(86) PCT No.: PCT/US2023/076166

§ 371 Date: Apr. 4, 2025

Related U.S. Application Data
(60) Provisional application No. 63/378,822, filed on Oct. 7, 2022.

(51) Int. Cl. H01R 13/627; H01R 12/70; H01R 13/629

(52) U.S. Cl. CPC H01R 13/627; H01R 12/7005; H01R 13/629

(57) ABSTRACT

A connector can include a connector body and a latch coupled to the connector body. The latch can be configured to couple to an anchor element upon movement of the connector body in a first direction. The latch can be configured to decouple from the anchor element upon movement of the connector body in a second direction different from the first direction.

### CROSS-REFERENCE TO RELATED APPLICATIONS

This application claims priority to U.S. Provisional Application Ser. No. 63/378,822 filed Oct. 7, 2022, the disclosure of which is hereby incorporated by reference as if set forth in its entirety herein.

### BACKGROUND

Electrical connectors are typically mated to complementary electrical components so as to establish electrical communication therebetween. In one application, electrical conductors of the electrical connectors are mounted to a complementary electrical component such as electrical cables or an underlying printed circuit board (PCB). In some examples, a first electrical cable connector can be mated with a second electrical connector that is mounted to a PCB. In some architectures, it is desirable for a high density of electrical connectors to be mounted onto the PCB. Thus, multiple electrical connectors are mounted to a relatively small footprint on the PCB. It can be desirable to easily mate and unmate electrical connectors to and from each other in tight spaces.

### SUMMARY

As a broad overview, examples described herein can generally relate interconnects that are configured to be repeatably separated from and repeatedly latched to a mating interconnect, but that can also be configured to be quickly and/or automatically unlatched or unlocked or separated from the mating interconnect without a user manually manipulating one or more of (i) the latch, (ii) an actuator that is physically attached to the latch, is in physical contact with the latch when the actuator is moved or manually manipulated, or both, or (iii) a pull tab attached to the latch or the actuator.

Interconnect types include, but are not limited to, any one or more of non-compressible fluid, compressible fluid, electrical and optical. An interconnect can include a first part and a second part. The first part can be configured to be latched to the second part. The second part can be configured to be latched to the first part. The first part can be configured to mate with the second part. The second part can be configured to mate with the first part. The first part can be configured to be automatically released or quickly disconnected from the second part, without damaging any portion of the first part or the second part, by applying an unmating force to the first part, the second part or both. The second part can be configured to be automatically released or quickly disconnected from the first part, without damaging any portion of the first part or the second part, by applying an unmating force to the first part, the second part, or both.

In one example, a data communication assembly includes a first data communication device having a housing body and data communication members supported by the first housing body. The communication assembly can further include an actuator supported by the housing body. The communication assembly can further include a latch supported by the housing body and configured to engage a second data communication device in a first configuration so as to prevent the first and second data communication devices from unmating. The actuator can be configured to urge the latch to a second configuration whereby the latch becomes disengaged from the second data communication device.

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1A is a perspective view of a data communication assembly including first and second electrical connectors mated to each other, wherein the second electrical connector is shown mounted to a substrate in one example;

FIG. 1B is a perspective view of an electrical connector assembly of the data communication assembly of FIG. 1A, with portions removed to illustrate first electrical conductors of the first electrical connector mated with second electrical conductors of the second electrical connector;

FIG. 2 is a perspective view of the first electrical connector of FIG. 1A, shown including the latch assembly of FIG. 2 and a connector housing that defines a first housing body and a second housing body;

FIG. 3 is a sectional view of the data communication assembly of FIG. 1A showing a latch assembly that is configured to releasably lock the first electrical connector to the second electrical connector, wherein an actuator of the latch assembly is shown in a first position and a latch of the latch assembly is shown in a first configuration;

FIG. 4A is a perspective view of a portion of the first electrical connector of FIG. 2, showing the first housing body and an actuator of the latch assembly that extends from the first housing body;

FIG. 4B is a cross-sectional view of the first housing body of FIG. 4A;

FIG. 5A is a front perspective view of a latch of the first electrical connector of FIG. 1A, configured to releasably secure the to the second electrical connector;

FIG. 5B is a rear perspective view of the latch of FIG. 3;

FIG. 6A is a perspective, sectional view of the second housing body of FIG. 2;

FIG. 6B is an enlarged portion of the latch of FIGS. 5A-5B shown engaged with the second housing body shown in FIG. 6A;

FIG. 7 is a side elevation view of a latch assembly including the latch of FIG. 3 and an actuator, showing the latch assembly in a first or locked configuration;

FIG. 8 is a side elevation view of the latch assembly of FIG. 7 shown in a second or unlocked configuration;

FIG. 9 is a perspective view of the second electrical connector of FIG. 1A;

FIG. 10A is a front perspective view of a second latch of the connector of FIG. 1A;

FIG. 10B is a rear perspective view of the second latch of the connector of FIG. 10A;

FIG. 11 is a side elevation view of a second latch assembly including the second latch of FIGS. 10A-10B and an actuator, showing the second latch assembly in a first or locked configuration;

FIG. 12 is a side elevation view of the second latch assembly of FIG. 12, shown in a second or unlocked configuration;

FIG. 13 is a perspective view of the first housing body of the first electrical connector of FIG. 2; and

FIG. 14 is a side elevation view of the data communication assembly of FIG. 1A, showing a plurality of first and second connectors mated to each other, wherein the second electrical connectors are mounted to the substrate.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

Disclosed herein are devices and methods for securing a first data communication device to a complementary second data communication device when mated to the first data communication device. Either or both of the first and second data communication devices can be configured as an electrical connector in one example. In other examples, one of the first and second data communication devices can be configured as an optical transceiver. Thus, signals can be communicated as electrical signals along electrical conductors and/or optical signals along optical cables.

The term “substantially” as used herein can refer to manufacturing tolerances. In one example, the term “substantially” as used with reference to a size, shape, direction, or other parameter can equal the stated size, shape, direction, or other parameter as well as +/−10% of the size, shape, direction, or other parameter can equal the stated size, shape, direction, or other parameter, including +/−9% of the size, shape, direction, or other parameter can equal the stated size, shape, direction, or other parameter, including +/−8% of the size, shape, direction, or other parameter can equal the stated size, shape, direction, or other parameter, including +/−7% of the size, shape, direction, or other parameter can equal the stated size, shape, direction, or other parameter, including +/−6% of the size, shape, direction, or other parameter can equal the stated size, shape, direction, or other parameter, including +/−5% of the size, shape, direction, or other parameter can equal the stated size, shape, direction, or other parameter, including +/−4% of the size, shape, direction, or other parameter can equal the stated size, shape, direction, or other parameter, including +/−3% of the size, shape, direction, or other parameter can equal the stated size, shape, direction, or other parameter, including +/−2% of the size, shape, direction, or other parameter can equal the stated size, shape, direction, or other parameter, including +/−1% of the size, shape, direction, or other parameter can equal the stated size, shape, direction, or other parameter.

Throughout the description below, reference made to singular elements using terms such as “a,” “an,” or “the” can also apply to plural elements or at least one of the elements. Thus, description below of a singular element applies with equal force and effect to a plurality of elements, including at least one of the elements. Conversely, reference to a plurality of elements can also apply with equal force and effect to a single one of the elements or at least one of the elements. Further, description of at least one element can apply with equal force and effect to a singular element or a plurality of the elements.

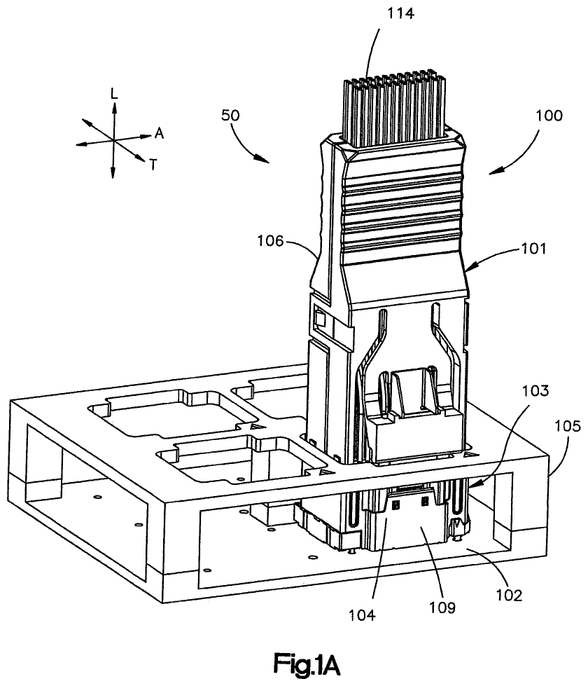

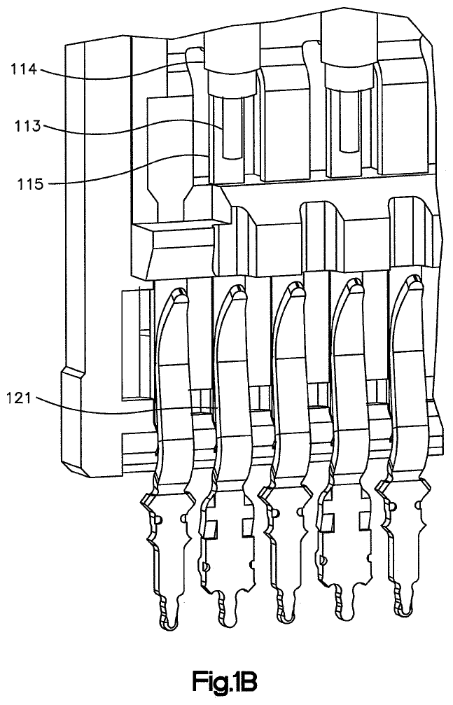

Referring initially to FIGS. 1A-1B, an assembly can include first and second devices that are configured to be mated with each other. For instance, the assembly can be configured as a communication assembly 50 wherein either or both of the first and second devices are configured as first and second communication devices configured to mate with each other. In one example, the first communication device can be configured as a first electrical connector 100, and the second communication device can be configured as a second electrical connector 104. Either or both of the electrical connectors 100 and 104 can be configured as an electrical connector that communicate data signals. Alternatively, at least one of the first and second data communication devices can be configured as a transceiver, such as an electrical transceiver or optical transceiver. In this regard, the first and second communication devices can be referred to as first and second data communication devices, respectively. Thus, the communication assembly 50 can be referred to as a data communication assembly. In still other examples, either or both of the electrical connectors 100 and 104 can be configured as electrical power connectors that communicate electrical power. Alternatively, still, either or both of the electrical connectors 100 and 104 can include electrical signal conductors that communicate data signals and electrical power conductors that communicate electrical power. It should be appreciated that the first and second devices can be configured as any suitable device as desired. The second device can be referred to as a complementary device that is complementary to the first communication device, such that the first communication device mates with the second communication device. When the first and second devices are configured as communication devices, it should be appreciated that the first and second devices can be configured as any suitable communication device as desired. Thus, when the first and second communication devices are configured as data communication devices, it should be appreciated that the first and second data communication devices can be configured as any suitable data communication device as desired.

As shown, the first communication device is configured as the first electrical connector 104, and the second communication device is configured as the second electrical connector 104. The second electrical connector 104 can be mounted to any suitable complementary data communication device, which can be configured as an electrical device such as a substrate 102. The substrate 102 can be configured as a printed circuit board (PCB) in some examples. Thus, the second electrical connector 104 can be referred to as a board connector.

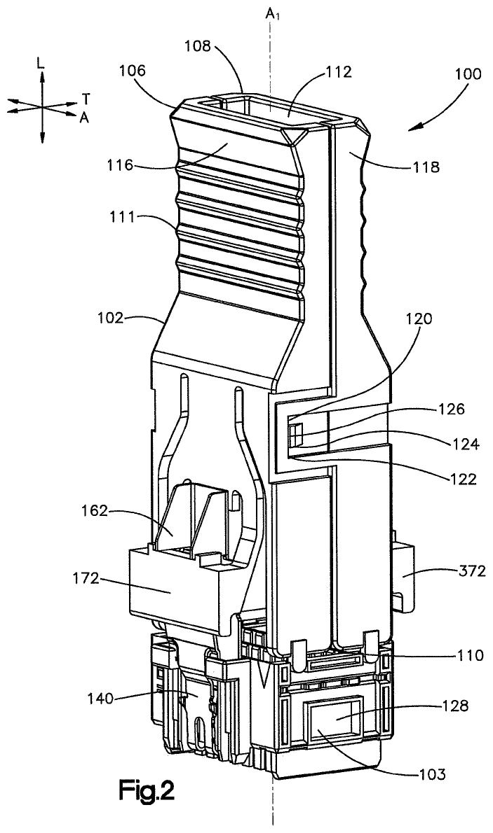

The first electrical connector 100 can be configured to mate to the second electrical connector 104 and can further be configured to unmate from the second electrical connector 104. The first electrical connector 100 can include a first connector portion 101 and a second connector portion 103. The second connector portion 103 can be secured to the first connector portion 103. The first connector portion 101 can include an electrically insulative first housing body 106 and a plurality of first data communication members such as electrical conductors 113 supported by the first housing body 106. The second connector portion 103 can include an electrically insulative second housing body 128 (shown in FIG. 2) and a plurality of second data communication members such as electrical conductors 115 supported by the second housing body 128. If the first electrical connector 100 is instead an optical transceiver, the first and second housing connector portions 101 and 103 can instead be configured as first and second data communication portions, at least one of which can have an optical transmit and/or an optical receive engine such as is the case for an optical transmitter, an optical receiver, or an optical transceiver.

As described above, the first connector portion 101, and thus the first electrical connector 100, can include the plurality of first electrical conductors 113 supported by the first housing body 106. The first electrical conductors 113 can be supported directly by the first housing body 106 or can be supported by one or more support structures that are, in turn, supported by the first housing body 106. The electrical conductors of the first plurality of electrical conductors 113 can be configured as desired. In one example, the first plurality of electrical conductors 113 can be configured as electrical cables 114 (shown in FIG. 1A) each having at least one electrical conductor surrounded by an electrical insulator. In this regard, the first connector portion 101 can be referred to as a cable connector portion. The electrical conductors of the electrical cables 114 can be electrically shielded or unshielded as desired.

The first electrical conductors 113 supported by the first housing body 106 can be in physical and electrical contact with respective ones of the second electrical conductors 115, as shown in FIG. 1B. In other examples, for instance when the first electrical connector 100 is configured as an optical transceiver, the cables can be configured as optical cables that carry optical signals.

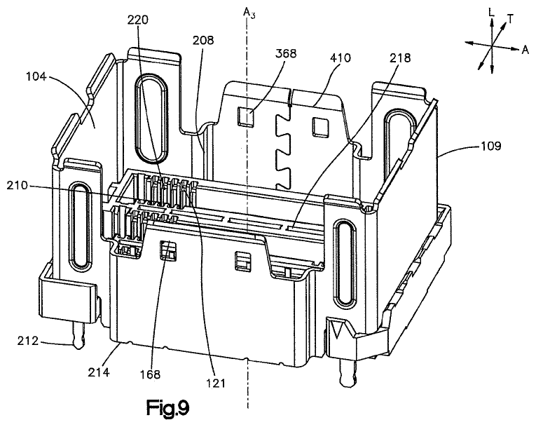

Referring to FIG. 9, the second electrical connector 104 can have an electrically insulative second connector housing 109 and a respective plurality of data communication members such as electrical conductors 121 supported by the second connector housing 109. While FIG. 9 shows only a few conductors 121 that extend along respective rows for illustrative purposes, it should be appreciated that the second electrical connector 121 can include full rows of conductors as desired. The second connector housing 109, and all connector housings described herein, can be defined by a single unitary housing or more than one housing body as desired that combine so as to define a connector housing. The electrical conductors 121 can have mating ends that are configured to mate with mating ends of respective second electrical conductors 115 when the first electrical connector 100 is mated with the second electrical conductor 104. The electrical conductors 121 can have mounting ends opposite the mating ends that are configured to be mounted to an electrical component such as the substrate 102 shown in FIG. 1A. The substrate 102 can be configured as a printed circuit board (PCB) in some examples. Accordingly, when the first and second electrical connectors 100 and 104 are mated with each other, the first electrical conductors 113 can be placed in electrical communication with the electrical conductors 121, and thus with the substrate 102. The electrical conductors 113, 115, and 121 can be arranged in respective rows that are arranged along a lateral direction A.

Turning to FIG. 1A, when the first electrical connector 100 is mated with the second electrical connector 104, the first electrical connector 100 can extend through a panel 105, such that the first connector portion 101 and the second connector portion 103 are disposed at opposed sides of the panel. The first electrical connector 100 can be releasably secured to the panel 105 as desired. Thus, the first electrical connector 100 can be referred to as a panel-mount connector in some examples. The first connector portion 101 can extend out with respect to a first surface of the panel 105, and the second connector portion 103 can extend out with respect to a second surface of the panel 105 that faces the second electrical connector 104 and the underlying substrate 102. The first and second surfaces can be opposite each other along a longitudinal direction L that is perpendicular to the lateral direction A.

Movement of the first electrical connector 100 in a first or mating direction relative to the second electrical connector 104 can mate the first electrical connector 100 to the second electrical connector 104. Movement of the first electrical connector 100 in a second or unmating direction opposite the first direction can decouple the first electrical connector 100 from the second electrical connector 104. The first direction can be towards the second electrical connector 104 and can thus also be towards the substrate 102. Conversely, the second direction can be away from the second electrical connector 104, and thus also away from the substrate 102. The first and second directions can be oriented along the longitudinal direction L.

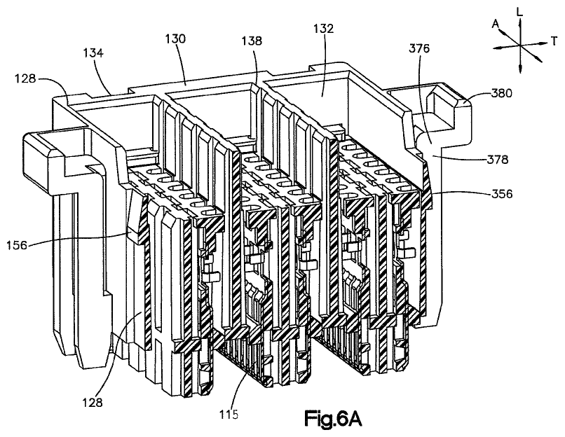

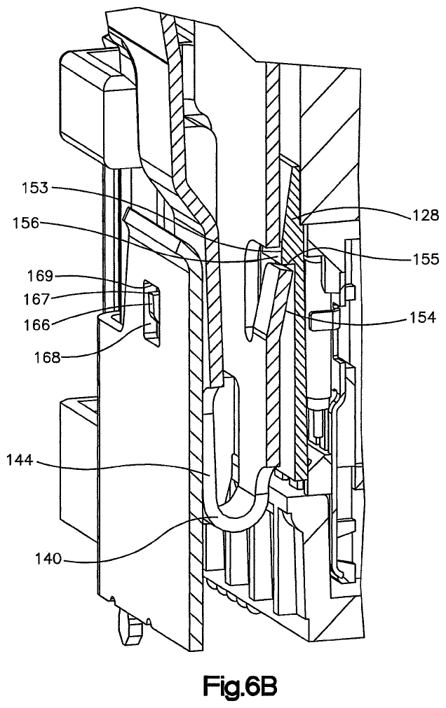

Turning back to FIG. 9, the second electrical connector 104 can extend along a central axis A₃ that is oriented along the longitudinal direction L. The second electrical connector 104 can include the housing 109 that, in turn, defines hollow a 208. A leadframe 218 can be positioned in the hollow 208 so as to support the electrical conductors 121. One or more signal conductors 220 can be coupled to the leadframe 218. It should be appreciated that the electrical conductors of the first and second electrical connectors can include signal conductors and ground conductors in any arrangement as desired. Adjacent ones of the signal conductors can define differential signal pairs. Alternatively, the electrical conductors can be unassigned. The hollow 208 can be configured to receive at least a portion of the second housing body 128 (FIG. 1A) when the first and second electrical connectors 100 and 104 are mated to each other. The first housing body 106 can be moved in the first direction such that the second housing body 128 enters the hollow 208 and electrical conductors 115 on the second housing body 128 (shown in FIG. 6A) electrically couple to the signal conductors 220 of the leadframe 218.

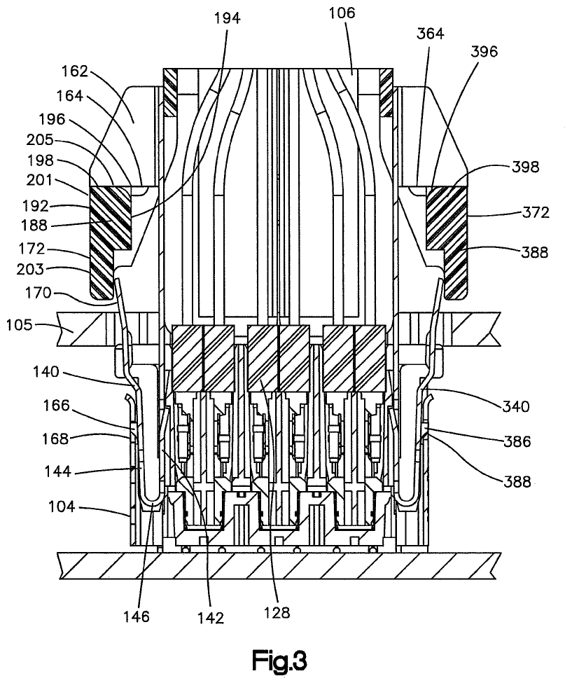

The hollow 208 can be configured to receive at least a portion of a latch 140 (see FIG. 3). The latch 140 can be made of any suitable material, such as plastic or metal. Thus, the latch 140 can be electrically conductive or electrically nonconductive as desired. The housing 109 can include a lip 210 at an entrance to the void 208, as shown in FIG. 9. The lip 210 can be disposed at an angle relative to the housing 109. The lip 210 can be angled away from the central axis A₃ as the lip 210 extends in the second direction. The second electrical connector 104 can include one or more fixation elements 212 configured to fix the second electrical connector 104 to the substrate 102. Each fixation element 212 can be a protrusion configured to be received by an opening in the substrate 102.

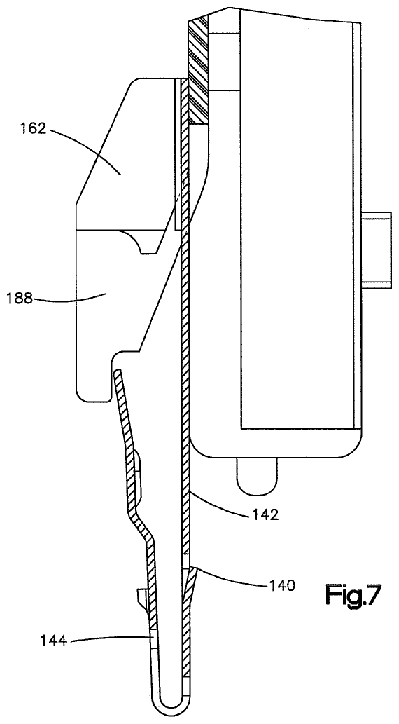

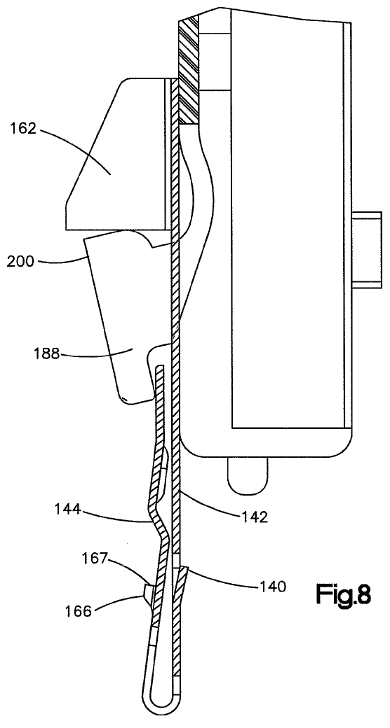

The first electrical connector 100 can include a latch assembly that is configured to detachably secure to the second electrical connector 104 when the first and second electrical connectors 100 and 104 are mated with each other. In particular, the latch assembly is movable between a first or locked configuration (FIG. 7) and a second or unlocked configuration (FIG. 8). In the first configuration, the latch assembly secures the first electrical connector 100 to the second electrical connector 104 such that the first electrical connector 100 is unable to be unmated from the second electrical connector 104. In the second configuration, the latch assembly does not prevent the first electrical connector 100 from being unmated from the second electrical connector 104.

Referring to FIG. 2, the first housing body 106 can be elongate along a respective central axis A₁, which can be oriented along the longitudinal direction L. The first housing body 106 can be engageable by a user to selectively move the first electrical connector 100 in the first direction and the second direction. In some examples, a user can engage the first housing body 106 manually. In other examples, a user can engage the first housing body 106 with a tool. The first housing body 106 can include a first end 108 and a second end 110. The first and second ends 108 and 110 can be opposite each other along the central axis A₁. For instance, the second end 110 can be opposite the first end 108 in the first direction. Conversely, the first and 108 can be opposite the second end 110 in the second direction. The first housing body 106 can define an internal void 112. The internal void 112 can extend from the first end 108 toward the second end 110. The internal void 112 can extend from the first end 108 to the second end 110. The internal void 112 can extend from the second end 110 toward the first end 108. The internal void 112 can extend through the first end 108. The internal void 112 can extend through the second end 110. The internal void 112 can be configured to receive a data communication element, which can be configured as the electrical cables 114 (FIG. 1). Alternatively, the data communication element can be configured as an optical cable that is configured to transmit optical signals. The electrical cables 114 can include a plurality of communication elements.

The first housing body 106 can include a first portion 116 and a second portion 118. In some examples, the first portion 116 is coupled to the second portion 118 by a coupler 120. In other examples, the first portion 116 and the second portion 118 are a monolithic element. The coupler 120 can be a latch, magnet, adhesive, or fastener. The coupler 120 can include an arm 122 defining a recess 124 configured to receive a protrusion 126 so as to secure the first portion 116 to the second portion 118. The arm 122 can be flexible. The arm 122 can flex as the protrusion 126 moves into the recess 124. The first portion 116 can be detachably coupled to the second portion 118. In one example, the electrical conductors 113 can be installed in the first housing body 106 prior to securing the first portion 116 to the second portion 118.

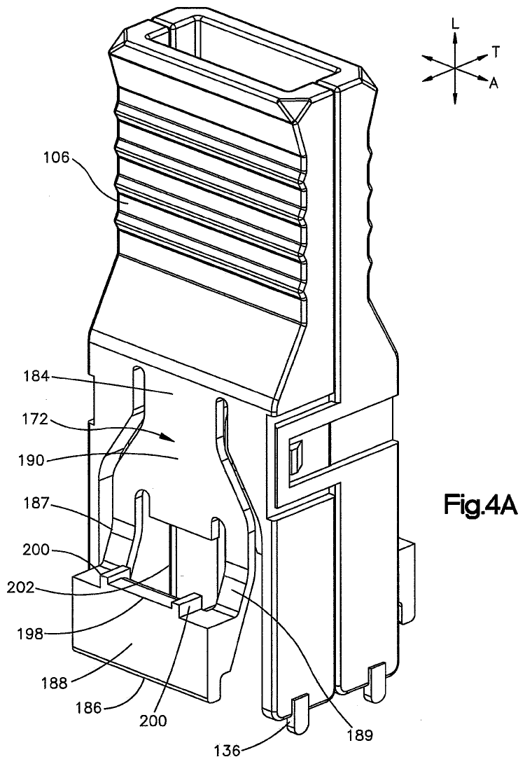

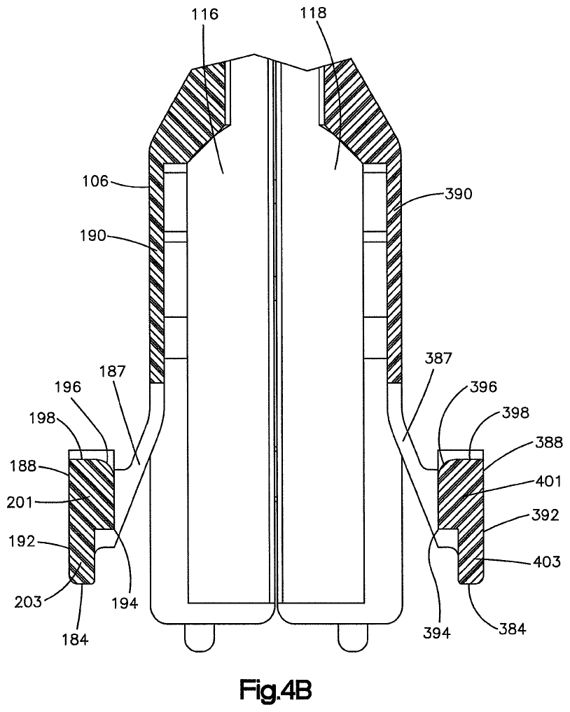

The first housing body 106 can be coupled to a second housing body 128. At least a portion of the second housing body 128 can extend into the internal void 112 of the first housing body 106. The second housing body 128 can include an outer wall 130 defining a respective internal void 132 (FIG. 6A). The second end 110 of the first housing body 106 can contact or otherwise face a first end of the outer wall 130. The outer wall 130 can include a coupling member 134 (FIG. 6A) adapted to couple to a complementary coupling member 136 (FIG. 4A) of the first housing body 106. One of the coupling member 134 and the connector body coupling member 136 can be a protrusion, and the other of the coupling member 134 and connector body coupling member 136 can be a protrusion that can be received in the recess. In some examples, the first housing body 106 can be movable relative to the second housing body 128. For instance, the first housing body 106 can be moveable in the longitudinal direction L relative to the second housing body 128. The coupling member 136 can be moveable relative to coupling member 134 as the first housing body 106 moves relative to the second housing body 128. The coupling member 136 engaged with the coupling member 134 can maintain the alignment of the first housing body 106 relative to the second housing body 128 as the first housing body 106 moves relative to the second housing body 128 along the longitudinal direction L. Alternatively, in other examples, the first housing body 106 can be positionally fixed to the second housing body 128, particularly with respect to relative movement along the longitudinal direction L.

Referring now to FIGS. 2-3, the first electrical connector 100 can include a latch assembly that includes the latch 140 configured to couple the first electrical connector 100 to the second electrical connector 104, and an actuator 172 that is configured to move or iterate the latch 140 between from the first configuration (FIG. 7) to the second configuration (FIG. 8) described above. In particular, the latch 140 can lock to the second electrical connector 104 in the first configuration in response to movement of the first electrical connector 100 relative to the second electrical connector 104 in the first direction so as to mate the electrical connectors 100 and 104. The latch 140 can move from the first configuration to the second configuration so as to decouple or unlock from the second electrical connector 104 as the first electrical connector 100 moves in the second direction with respect to the second electrical connector 104 that unmates the electrical connectors. The latch 140 can decouple from the second electrical connector 104 in response to movement of the first electrical connector 100 relative to the second electrical connector 104 in the second direction. It is appreciated that the latch 140 can decouple or unlock from the second electrical connector 104 without requiring a user to perform a separate decoupling action on the latch 140.

Referring to in particular to FIGS. 2-4B, the first electrical connector 100 can include the actuator 172 that is supported by the first housing body 106. For instance, the actuator 172 can extend from the first housing body 106. In one example, the actuator 172 can be monolithic with the first housing body 106 so as to define a single unitary structure. In another example, the actuator 172 can be separate from and attached to the first housing body 106. As will now be described, the actuator 172 can be movably supported by the first housing body 106 from a first position to a second flexed position, with respect to the first housing body 106. The first position can be a natural or relaxed position, or the actuator 172 can be pretensioned such that the first position can be a flexed position, but less flexed than the second flexed position.

The actuator 172 can define a first end 184 that extends from the first housing body 106, and a second end 186 opposite the first end 104. The second end 186 can be a free end in some examples. The actuator 172 can include an actuator head 188 that is configured to engage the latch 140 so as to move the latch 140 from the first configuration (FIG. 7) to the second configuration (FIG. 8). The actuator 172 can extend from the first housing body 106 to the actuator head 188. In one example, the actuator 172 can include an actuator body 190 that can be configured as a plate separated on three of its four sides from the first housing body 106 by a slot that extends through first housing body 106. The fourth side of the actuator body 190 can define an interface with the first housing body 106. The actuator body 190 can define the first end 184 and can extend toward the actuator head 188. The actuator body 190 can be coplanar with the housing body 106 in its natural position in some examples.

The actuator 172 can further include at least one actuator arm, such as a first actuator arm 187 and a second actuator arm 189 that extend from the actuator body 190 to the actuator head 188. The first and second arms 187 and 189 can flare away from the first housing body 106 as they extend in the first direction toward the actuator head 188. The actuator head 188 can extend from respective distal ends of the first and second arms 187 and 189, such that the actuator head 188 is spaced from the first housing body 106. The first and second arms 187 and 189 can be spaced from each other along a direction that is perpendicular to a direction that separates first and second surfaces 194 and 192 of the actuator head 188 (described below). Thus, in one example, the first and second arms 187 and 189 can be spaced from each other along the lateral direction A. The actuator 172 can thus define an opening 202 that extends from the first arm 187 to the second arm 189. The latch 140, and in particular a first latch arm 142, can extend through the opening 202 during use.

Either or both of the actuator body 190 and the at least one arm is configured to resiliently flex with respect to the first housing body 106 so as to move the actuator 172 from its first position to its flexed position. Movement of the actuator 172 from its first position to its flexed position causes the actuator head 188 to move to a position, whereby the actuator head 188 causes the latch 140 to move from the first configuration to the second configuration. In one example, the actuator head 188 moves toward the first housing body 106 so as to cause the latch 104 to move from the first configuration to the second configuration.

The actuator head 188 can include a first or inner surface 194 and a second or outer surface 192 opposite the first surface 194. The first surface 194 can face the first housing body 106. Thus, the first surface 194 can be disposed closer to the first housing body 106 with respect to a distance that spaces the second surface 192 from the first housing body 106. The first and second surfaces 194 and 192 can be opposite each other along a select direction that is angularly offset, such as substantially perpendicular to the longitudinal direction L. In one example, the first and second surfaces 194 and 192 are opposite each other along a transverse direction T that is perpendicular to each of the longitudinal direction L and the lateral direction A. Similarly, the first and second surfaces 194 and 192 can be spaced from the first housing body 106 along the transverse direction T. In other examples, the first and second surfaces 194 and 192 are opposite each other along the lateral direction A, depending on which side of the first hosing body 106 that the actuator 172 is disposed. One of the first and second surfaces 194 and 192 can define an actuation surface that is configured to contact the latch 140 so as to apply a force to the latch 140 that urges the latch to move from the first configuration to the second configuration. In one example, the first surface 194 can define the actuation surface, though it is appreciated that the latch 140 and actuator 172 can be alternatively constructed such that the second surface 192 defines the actuation surface.

The actuator head 188 can include a first portion 201 and a second portion 203. The second portion 203 can have a smaller thickness along the select direction than the first portion 201. The second portion 203 can extend from the first portion 201 in the first direction. Thus, the second portion 203 can be positioned closer to the second end 110 of the first housing body 106 than the first portion 201. The first surface 194 at the second portion 203 can be outwardly offset away from the first housing body 106 first surface 194 at the first portion 201. The second portion 203 can be configured to bear against the latch 140 so as to urge the latch 140 to move from the first configuration to the second configuration. In particular, the first surface 194 at the second portion 203 can bias a latch actuation surface 170 of the latch 140 to move from the first configuration to the second configuration.

The actuator head 188, and in particular the first portion 201, can define a static bearing surface 198 that is configured to bear or seat against a latch engagement surface 164 of the latch 140 when the actuator 172 is in the first position. The actuator head 188, and in particular first portion 201, can further define a dynamic bearing surface 196 that is configured to bear against the engagement surface 164 of the latch 140 as the actuator 172 moves from the first position to the second position. In one example, the static bearing surface 198 can be a flat surface. The dynamic bearing surface 196 can be a curved surface, which can be defined by a fillet, which extends between the static bearing surface 198 and the first surface 194 of the actuator head 188. For instance, the dynamic bearing surface 196 can extend from the static bearing surface 198 to the first surface 194 of the actuator head 188. In one example, the dynamic bearing surface 196 can extend from the static bearing surface 198 to the first surface 194 at the first portion 201 of the actuator head 188.

As the actuator 172 is flexed from the first position to the second position, the dynamic bearing surface 196 can ride along the engagement surface of the latch 140. In particular, movement of the first housing body 106 in the second direction with respect to the second housing body 128, and thus with respect to the second electrical connector 104, causes either or both of the actuator body 190 and the at least one arm of the actuator 172 to flex, which causes the actuator head 188 to both move toward the first housing body 106 and to angulate so as to change its angular orientation. In other examples the actuator head 188 can rotate about a fixed or translatable axis of rotation, such that the actuator head 188 rotates, which thus causes the actuator head 188 to angulate. As the actuator head 188 travels toward the first housing body 106 and angulates, the dynamic bearing surface 196 moves into engagement with at least one engagement surface 164 of the latch 140. In one example, the dynamic bearing surface 196 can ride along the engagement surface of the latch 140 as it angulates without slippage between the surfaces. In other examples, the surfaces can slide along each other.

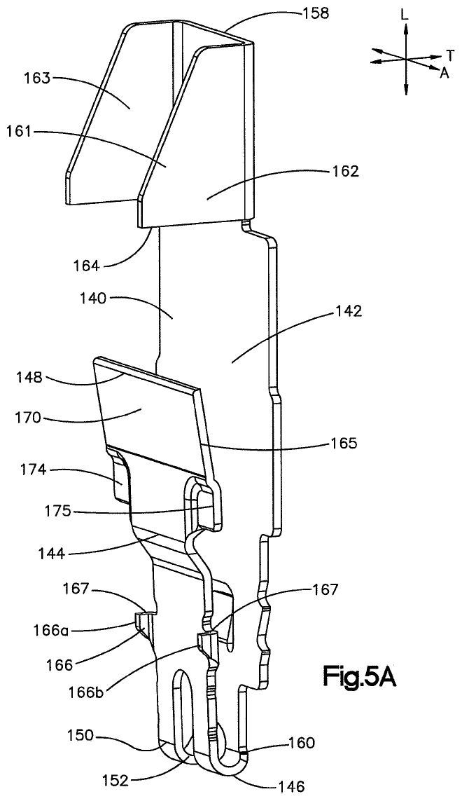

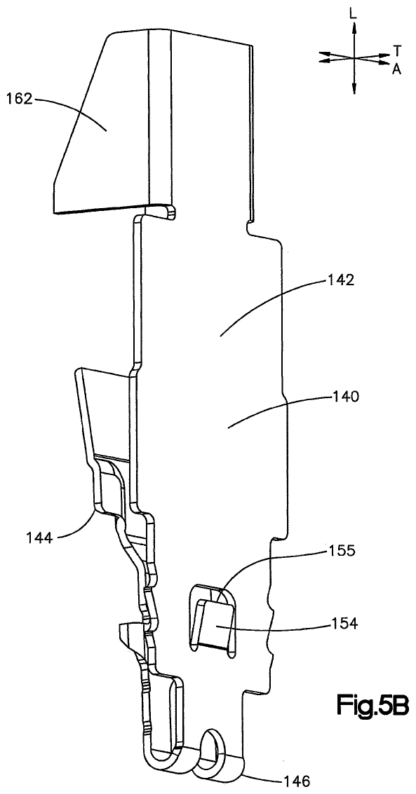

The actuator head 188 can define one or more alignment members 200 that project out from the static bearing surface 198. The alignment members 200 can project out from the static bearing surface 198 in the second direction, in one example. The alignment members 200 can be spaced apart a distance that can be measured along a third direction that is angularly offset, such as perpendicular to the longitudinal direction L and the select direction. Thus, in one example, the alignment members 200 can be spaced from each other along the lateral direction A. The alignment members 200 can be spaced from each other a sufficient distance such that a latch engagement member 162 of the latch 140 that defines the engagement surface 164 can abut the static bearing surface 198 between the alignment members 200. Thus, the alignment members 200 can be configured to maintain alignment of the latch 140 relative to the actuator 172. In one example, the alignment members 200 can be spaced by a distance such that the engagement member 162 of the latch 140 is adjacent the alignment members 200. In some examples, the alignment members 200 can abut the engagement member 162. In other examples, the alignment members 200 are spaced from the engagement member 162 along the second direction. As described above, the engagement member 162, and thus the at least one engagement surface 164, can be disposed between the alignment members 200. It is recognized that in other examples, the alignment members 200 can be disposed between first and second engagement arms 161 and 163 of the engagement member 162 (see FIG. 5A). The engagement member 162 can define a length along the select direction that is greater than a distance between first latch arm 142 and the second latch arm 144 along the select direction.

The latch 140 will now be described in detail with reference to FIGS. 5A-5B, 7, and 8. In particular, the latch 140 can include a first or securement portion configured as a first latch arm 142 and a second or engagement portion configured as a second latch arm 144. The second latch arm 144 can extend from the first latch arm 142. The first latch arm 142 and the second latch arm 144 can be a monolithic construct. Alternatively, the first latch arm 142 and the second latch arm 144 can be separate from each other and attached to each other as desired. In this regard, an entirety of the latch 140 can be a single monolithic unitary component. Alternatively, one or more parts of the latch 140 can be separate from and attached to other parts of the latch 140 as desired. The latch 140 can further include a hinge 146 that extends from the first latch arm 142 to the second latch arm 144. The hinge 146 can define a u-shape such that at least respective portions of the first latch arm and the second latch arm 144 are aligned with each other and spaced from each other along the select direction. As described above, the select direction can be defined by the transverse direction T. Alternatively, the select direction can be defined by the lateral direction A. In some examples, the hinge 146 is a living hinge. The first latch arm 142, second latch arm 144, and hinge 146 can be a monolithic construct as desired. In other examples, the hinge 146 is any suitable alternative hinge as desired.

At least the hinge 146 can be resiliently flexible, such that at least one of the first latch arm 142 and the second latch arm 144 is movable relative to the other of the first latch arm 142 and the second latch arm 144 from the first configuration (FIG. 7) to the second configuration (FIG. 8), for instance about the hinge 146. The hinge 146 can bias the latch 140 toward or to the first configuration. In one example, the first latch arm 142 is secured to the first housing body 106, and the second latch arm 144 is movable relative to the first latch arm 142 about the hinge 146. For instance, the second latch arm 144 can be movable in the select direction relative to the first latch arm 142 about the hinge 146. In one example, the hinge 146 can flex as the second latch arm 144 moves relative to the first latch arm 142. In one example, the second latch arm 144 can be movable along an arcuate path relative to the first latch arm 142. The arcuate path can include a directional component defined by the select direction.

The second latch arm 144 can include a free end 148, and a second end 150 opposite the first end 148. The hinge 146 can extend from the first end 148. The second end 150 can be a free end. The first end 148 can be spaced from the first latch arm 142 along the select direction by a first distance when the latch 140 is in the first configuration (FIG. 7). The first end 148 can be spaced from the first latch arm 142 along the select direction by a second distance when the latch 140 is in the second configuration (FIG. 8). The first distance can be greater than the second distance. The second latch arm 144 can be cantilevered from the hinge 146. The latch 140 can include a relief slot 152 that extends through the hinge 146. The relief slot 152 can reduce the force required to move the second latch arm 144 relative to the first latch arm 142. In other examples, the relief slot 152 can be a portion of the hinge 146 having reduced thickness compared to an adjacent portion of the latch 140. While the latch 140 flexes about the hinge 146 in one example between the first and second configurations, the latch 140 can flex about any suitable alternative structure as desired.

The latch 140 can be secured to the first electrical connector 100. For instance, the latch 140 can be operatively captured between the first connector portion 101 and the second connector portion 103 with respect to relative motion along the longitudinal direction L. For example, the first latch arm 142 can be secured to the first connector portion 101 with respect to movement between the latch 142 and the first connector portion 101 in the first direction. Thus, the first latch arm 142 can similarly be secured to all elements of the first connector portion 101 with respect to relative movement between the first latch arm 142 and the elements of the first connector portion 101, including the first housing body 106 and the actuator head 188. Further, the first latch arm 142 can be secured to the second connector portion 103 with respect to movement between the first latch arm 142 and the second connector portion 103 in the second direction. Thus, the first latch arm 142 can similarly be secured to all elements of the second connector portion 103 with respect to movement between the first latch arm 142 and the elements of the second connector portion 103, including the second housing body 128.

In one example, the latch 140, and in particular the first latch arm 142, can include at least one first engagement member 162 that is configured to be secured to the first connector portion 101 with respect to relative movement between the first latch arm 142 and the first connector portion 101 in the first direction. The at least one first engagement member 164 can include at least one first engagement surface 164 that is configured to abut a first stop surface of the first electrical connector 100, and in particular of the first connector portion 101. In one example, the first stop surface can be defined by the static bearing surface 198 (see FIG. 3) of the actuator 172 when the actuator is in the first position, and the dynamic bearing surface 196 when the actuator moves to the second position. The static bearing surface 198 and the dynamic bearing surface 196 can combine so as to define a single actuator stop surface 205 of the actuator 172, and thus of the first connector portion 101. Abutment between the at least one first engagement surface 164 and the stop surface of the first connector portion 101 prevents the engagement member 162, and thus the first latch arm 142, from moving in the first direction with respect to the first connector portion 101, and thus with respect to the first electrical connector 100. In one example, the first engagement member 162 can include first and second engagement arms 161 and 163 that are spaced from each other along the third direction that is perpendicular to each of the longitudinal direction L and the select direction. Each of the first and second engagement arms 161 and 163 can define a respective first engagement surface 164 of the type described herein. The engagement arms 161 and 163 can extend from a support region of the first latch arm 142 away from the first housing body 106.

Referring now to FIGS. 3 and 5A-6B, the latch 140, and in particular the first latch arm 142, can further include a second engagement member 154 configured to secure the latch 140 to the first electrical connector 100 with respect to movement of the first latch arm 142 in the second direction relative to the first electrical connector 101, and in particular relative to the second connector portion 103. The second engagement member 154 can be configured as a tab that projects away from the first latch arm 142. In particular, the second engagement member 154 can extend in a direction away from the second latch arm 144 of the latch as it extends in the second direction. The second engagement member 154 can define a second engagement surface 155 that faces generally in the second direction.

The second engagement member 154 can be configured to engage a complementary connector engagement member 153, and in particular a second stop surface of the complementary connector engagement member 153, of the first electrical connector 100, and in particular of the second connector portion 103. The connector engagement member 153, and thus second stop surface, can be defined by any suitable surface of or supported by, directly or indirectly, the second housing body 128. In one example, the second housing body 128, and in particular a flange 156 of the second housing body 128, define the second stop surface that faces generally in the first direction. In one example, the flange 156 can extend outward an external surface of the second housing body 128. The second engagement surface 155 of the second engagement member 154 can face generally in the second direction, and thus faces the second stop surface of the flange 156. Thus, abutment between the second stop surface of the second housing body 128 and the second engagement surface 155 can prevent movement of the first latch arm 142 in the second direction with respect to the first electrical connector 100, and in particular with respect to the second housing body 103.

In some examples, it should be appreciated that abutment between the latch 140 and the first and second stop surfaces can prevent movement of the latch 140 in the first and second directions relative to the first electrical connector. In other examples, movement of the latch 140 along the longitudinal direction can be permitted to allow the first connector portion 101 to move relative to the second connector portion 103 in the second direction, but not enough movement that allows the first connector portion 101 to separate from the second connector portion 103. In this regard, as shown at FIG. 1B, the first electrical conductors 113 can overlap the second electrical conductors 115 a sufficient overlap distance such that the conductors 113 and 115 can wipe along each other and maintain physical and electrical contact with each other even when the first connector portion 101 is moved away from the second connector portion 103 a distance less than the overlap distance. Thus, it can be said that the latch 104 can engage the first electrical connector 100, and in particular the first and second connector portions 101 and 103 in the manner described above so as to substantially prevent movement of the latch 104 of a sufficient distance that allows the first and second electrical conductors 113 and 115 to separate from each other.

For instance, the engagement surface 164 and the second stop surface of the connector engagement member 153 are spaced from each other a first longitudinal distance along the longitudinal direction L, and the actuator stop surface 205 and the second engagement surface 155 of the latch 140 are spaced from each other a second longitudinal distance along the longitudinal direction. The second longitudinal distance can be less than the first longitudinal distance. Therefore, the first connector portion 101 can be movable in the second direction with respect to the second connector portion 103. The second longitudinal distance can be less than the first longitudinal distance by a difference that can be less than a longitudinal distance along which the first electrical conductors 113 overlap the second electrical conductors 115. Therefore, the first connector portion 101 can be movable in the second direction with respect to the second connector portion 103 only a distance that does not cause the first and second electrical conductors 113 and 115 to disconnect from each other. In other examples, the first electrical connector 100 can be constructed such that when the latch 104 is in the first configuration, the first housing body 106 is movable in the second direction with respect to the second housing body 128 in the manner described above, while the respective first and second electrical conductors 113 and 115 remain stationary and mated with each other.

While the first latch arm 142 can attach to the first and second connector portions 101 and 103, respectively, to substantially prevent relative movement between the first latch arm 142 and the first connector portion 101 in the first and second directions, respectively, in the manner described above. Alternatively, it is recognized that the electrical connector 100 can be configured such that the first latch arm 142 attaches to the first connector portion 101 to substantially prevent relative movement between the first latch arm 142 and the first portion 101 in the second direction, and attaches to the second connector portion 103 to substantially prevent relative movement between the first latch arm 142 and the second connector portion 103 in the first direction. Thus, it can be said that the first latch arm 142 can attach to the first connector portion 101 to substantially prevent relative movement between the first latch arm 142 and the first connector portion 101 in one of the first and second directions, and can attach to the second connector portion 103 to substantially prevent relative movement between the first latch arm 142 and the second connector portion 103 in the other of the first and second directions. While certain suitable methods and apparatus for securing the first latch arm 142 to the first electrical connector 100 have been described, it should be appreciated that the latch 140 can attach to the first electrical connector 100, and in particular to the first and second connector portions 101 and 103 in any suitable alternative manner as desired.

With continuing reference to FIGS. 3 and 5A-6B, the latch 140 can include at least one first latch fixation member 166 configured to engage the second electrical connector 104 so as to prevent the first electrical connector 100 from moving in the second direction a sufficient distance to unmate the first and second electrical connectors 100 and 104 when the latch 140 is in the first configuration (FIG. 7). When the latch 140 is moved to the second configuration (FIG. 8), the at least one fixation member 166 is disengaged from the second electrical connector 104, thereby allowing the first electrical connector 100 to move in the second direction relative to the second electrical connector 104 a sufficient distance to unmate the first electrical connector 100 from the second electrical connector 104. The latch fixation member 166 can move in the same direction as the free end 148, such that, when the latch 140 is moved to the second configuration, the latch fixation member 166 can move towards the first latch arm 142. In one example, the first electrical connector 100 can be removed entirely from the second electrical connector 104.

In one example, the at least one fixation member 166 can project out from the second latch arm 144 of the latch 140 along a direction that is angularly offset, for instance perpendicular to the longitudinal direction L. In one example, at least one fixation member 166 can project out from the second latch arm 144 of the latch 140 along the select direction. For instance, the at least one fixation member 166 can project out from the second latch arm 144 of the latch 140 in a direction away from the first latch arm 142. The fixation member 166 can extend out from the second latch arm 144 at a location between the first end 148 and the second end 150. The at least one first fixation member 166 can define a first fixation surface 167 that is configured to abut a complementary connector fixation surface 169 of the second electrical connector 104. The first fixation surface 167 can face generally in the second direction. The at least one fixation member 166 can include first and second fixation members 166a and 166b that can be spaced from here any suitable direction, such as the third direction that is perpendicular to the select direction and the longitudinal direction L. Each of the first and second fixation members 166a and 166b can define a respective first fixation surface 167.

The second electrical connector 104 can define a second complementary connector fixation member 168 that defines the second or connector fixation surface 169. The connector fixation surface 169 can face generally in the first direction. When the latch 140 is in the first configuration, each first fixation surface 167 can be aligned with the second fixation surface 169 along the longitudinal direction L. Because the latch 140 is secured to the first electrical connector 100 in the manner described above, and because the first and second fixation surfaces 167 and 169 are aligned with each other when the latch 140 is in the first configuration, the first and second fixation surfaces 167 and 169 abut each other so as to prevent the first electrical connector 100 from being unmated and separated from the second electrical connector 104.

One of the latch fixation member 166 and the connector fixation member 168 can be a projection, and the other of the latch fixation member 166 and the connector fixation member 168 can be an aperture that is configured to receive the projection so as to place the respective fixation surfaces 167 and 169 in alignment with each other in the manner described above. For instance, the latch fixation member 166 can be configured as the projection, and the connector fixation member 168 can be configured as the recess. The recess can extend through the second connector housing 109 in one example. In other examples, the second electrical connector 104 can include a plate that at least partially surrounds or is otherwise adjacent to the second connector housing 109. The plate can define the aperture as desired. Thus, reference to a housing of the second electrical connector 104 that defines the connector fixation member to engage the latch fixation member 166 can apply to either or both of the connector housing 166 and the plate. The locking plate can be metallic or otherwise electrically conductive or can be electrically insulative as desired.

Referring now also to FIGS. 2-3 and 7-8, and as described above, the latch 140 can be resiliently movable, or configured to resiliently flex, from a first configuration to a second configuration. The latch 140 can be devoid of springs, such as coil springs, between the first and second latch arms 142 and 144. The latch 140 can be electrically isolated from all electrical conductors. In the first configuration, the at least one latch fixation member 166, and in particular the fixation surface 167, is aligned with the connector fixation member 168, and in particular the fixation surface, along the longitudinal direction L. In the second configuration, the latch fixation member 166 can be disengaged from the connector fixation member 168. In particular, the at least one latch fixation member 166, and in particular the fixation surface 167, is moved out of alignment with the connector fixation member 168, and in particular the fixation surface, along the longitudinal direction L. The latch 140 can be naturally biased to the first configuration, so that the first and second electrical connectors 100 and 104 cannot be inadvertently unmated and separated but can only be unmated with a pull force applied to either or both of first housing body 106 and the cables 114. The latch 140 can be caused to move from the first configuration to the second configuration without damaging the cables. The latch 140 can be caused to move from the first configuration to the second configuration without damaging the first electrical connector 100. The latch 140 can be caused to move from the first configuration to the second configuration without damaging the second electrical connector 104. The latch 140 can be caused to move from the first configuration to the second configuration without damaging the latch 140. The latch 140 can be caused to move from the first configuration to the second configuration without damaging the electrical conductors 113 and/or 115. In examples where the first data communication device, such as the first electrical connector 100, does not include cables, the pull force can be applied only to the first housing body 106 to cause the first and second electrical connectors 100 and 104 to be unmated. For instance, the latch 140 does not move from the first configuration to the second configuration by applying a push force to the first electrical connectors 100. In some examples, the first electrical connector 100 can be devoid of either or both of a pull tab and a push button that is actuated to move the latch 140 between the first and second configurations.

During operation, when it is desired to unmate the first electrical connector 100 from the second electrical connector 104, a disengagement force can be applied to either or both of the first housing body 106 and the cables 114 in the second direction with respect to the second electrical connector 104. When the disengagement force reaches a predetermined threshold, the actuator 172 causes the latch 140 to move to the second configuration, as will now be described. The force can be applied manually or using any suitable instrument as desired. If the disengagement force is applied to the cables 114, the force is high enough to prevent an inadvertent disengagement force, for instance as might be applied from shock and vibration during use but is low enough to avoid damage to the latch 140, actuator 172, and cables 114.

The disengagement force in the second direction causes the second latch arm 144 to move in the select direction toward the first latch arm 142 to define the second configuration of the latch 140. Thus, it can be said that the disengagement force is oriented in a direction that is different from the direction that the latch arm 144 moves as the latch 140 iterates from the first configuration to the second configuration. Further, it should be appreciated that the latch 140 is compressed by the actuator 172 as it iterates from the first configuration to the second configuration. The first housing body 106 can have a textured outer surface 111 that is configured to be gripped when applying the disengagement force. As described above, when the latch 40 is in the first configuration, the first connector portion 101 can be movable in the second direction with respect to the second connector portion 103, but not so much that causes the first and second electrical conductors 113 and 115 (see FIG. 1B) to disengage each other.

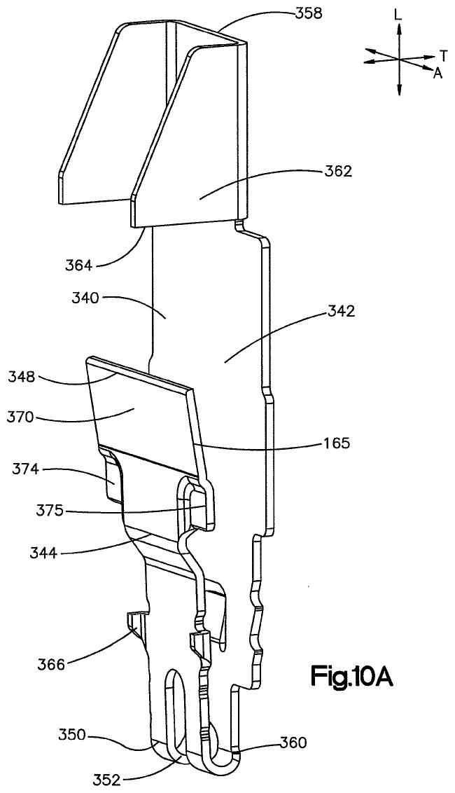

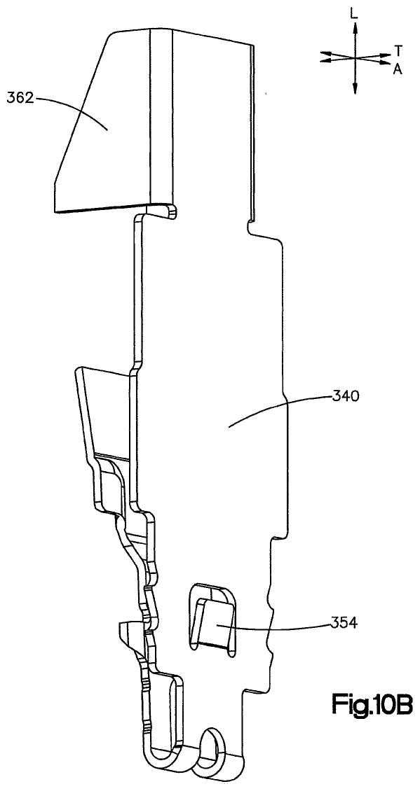

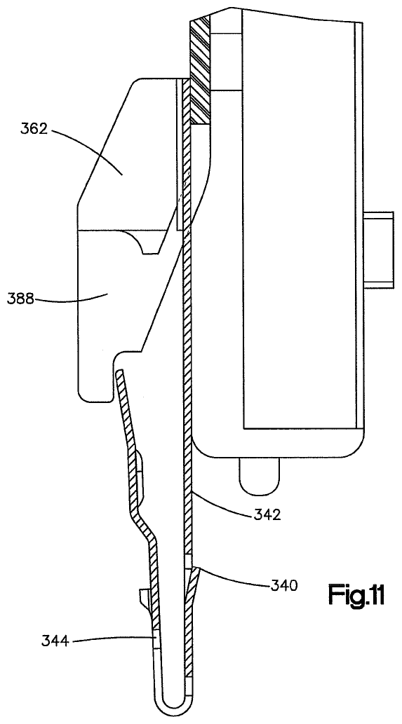

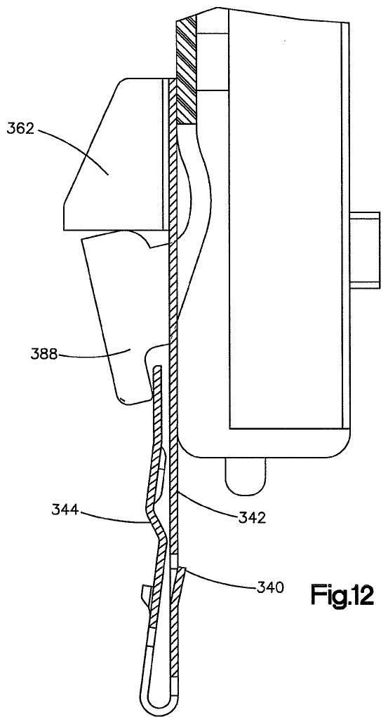

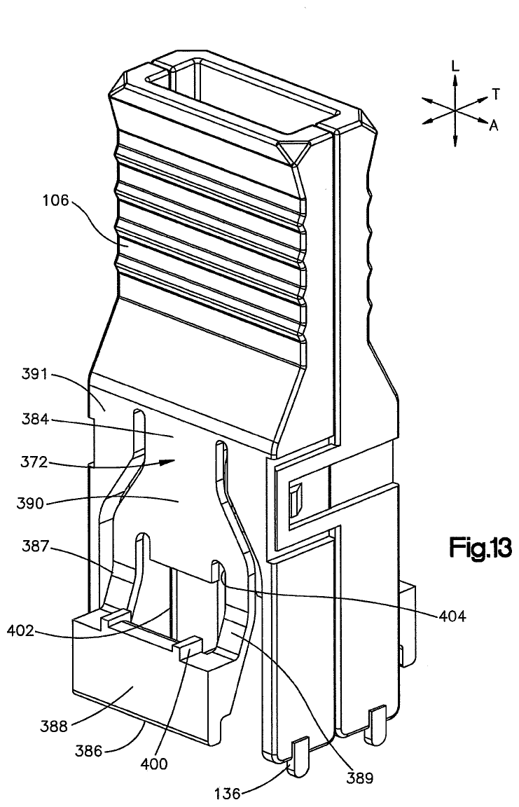

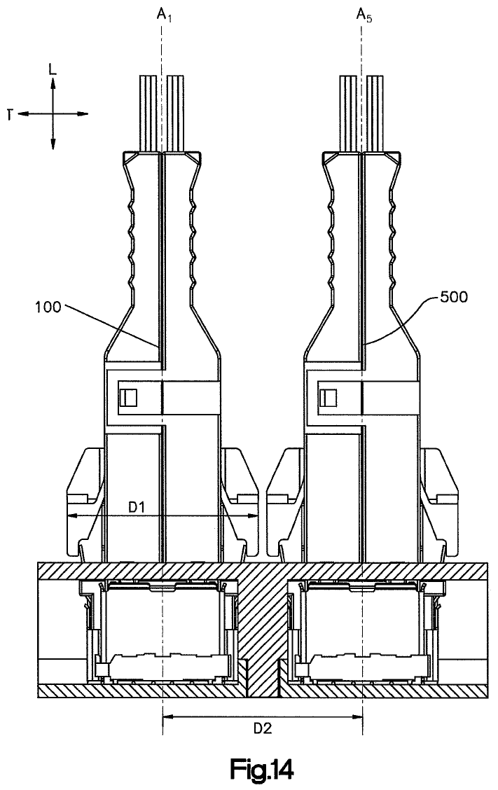

Movement of the first connector portion 101, and in particular of the first housing body 106, in the second direction with respect to the second connector portion 103, and in particular the second housing body 128, causes the actuator 172 to move from the first position to the flexed position as described above, which thereby causes the latch 140 to move from the first configuration to the second configuration. At least one of the actuator body 190 and the at least one actuator arm such as the actuator arms 187 and 189 (see FIG. 4A) can be flexible. Accordingly, as the first housing body 106 moves in the second direction relative to the second housing body 128, the actuator head 188, and in particular the static bearing surface 198 of the actuator 172, bears against the engagement member 162 of the latch 140, and in particular against the engagement surface 162. Continued movement of the first housing body 106 in the second direction relative to the second housing body 128 causes the actuator arms 187 and 189 to flex inward or toward the central axis A₁ (see FIG. 14) of the first electrical connector 100 in the select direction, or toward respective first and second actuator arms 387 and 389 of a second actuator 370 if the electrical connector 100 includes the second actuator 370 (see FIGS. 10A-13). The central axis A₁ can extend along the longitudinal direction L. As the arms 187 and 189 flex inward, the arms 187 and 189 cause the actuator head 188 to similarly move inward in the select direction and angulate. As the actuator head 188 angulates, the dynamic bearing surface 196 bears against the engagement surface 164 of the latch engagement member 162. The curvature of the dynamic bearing surface 196 allows the dynamic bearing surface 196 to remain in contact with the engagement surface 164 as the actuator head 188 continues to angulate while the first housing body 106 continues to move in the second direction. The actuator head 188 can angulate such that the second portion 203 moves inward at a greater rate than the first portion 201 of the actuator head 188. As the actuator head 188 moves in the inward direction, the actuator head 188 bears against a latch actuation body 165 of the latch 140. The latch actuation body 165 can define a latch actuation surface 170 of the latch 140. The latch actuation surface 170 can be defined by the second latch arm 144 of the latch 140. The latch actuation surface 170 can be disposed between the first end 148 of the second latch arm 144 and the latch fixation member 166. The fixation member 168 can be positioned between the engagement surface 170 and the second end 150 of the second latch arm 144. The actuation surface 170 can face away from the first latch arm 142 in the select direction. In some examples, the actuation surface 170 can define the first end 148 of the second latch arm 144. The first surface 194 at the second portion 203 of the actuator head 188, also referred to as an actuator surface, can bear against the latch actuation surface 170. In particular, the actuator head 188 can urge the latch actuation surface 170, and thus the second arm 144, to move in a disengagement direction. In particular, the latch actuation surface 170 can move inward toward the first latch arm 142. As described above, the latch 140, and in particular the hinge 146, can resiliently flex as the latch actuation surface 170 moves toward the first latch arm 142. Alternatively or additionally, the second latch arm 144 can resiliently flex as the latch actuation surface 170 moves in the disengagement direction. Thus, at least one latch arm, such as the second latch arm 144, is automatically moved in the select direction when the actuator 172 is moved. Further, the at least one latch arm, such as the second latch arm 144, is automatically moved in the select direction when the disengagement force is applied to the first housing body, or any suitable alternative housing of the first electrical connector 100 that supports the actuator 172 in the manner described herein. Further, the latch assembly can be constructed as described herein such that the second latch arm 144 is only physically contacted, directly or indirectly, by the actuator 172. Further still, the actuator 172 causes the latch 140 to move to the second configuration by only touching and applying a force to the housing body 106 and/or electrical cables 114. Further still, the latch assembly can be constructed as described herein such that the latch arms 142 and 144 are only compressed to the second configuration by the actuator 172, and are only released to move to the first configuration by the actuator 172.

Movement of the second latch arm 144 in the disengagement direction causes the latch fixation member 166, which is carried by the second latch arm 144, to similarly move in the disengagement direction. The second latch arm 144 is urged by the actuator head 188 to move in the disengagement direction a sufficient distance such that the latch fixation member 166 disengages the connector fixation member 168. In particular, the latch fixation member moves out of alignment with the connector fixation surface 169 of the second electrical connector 204. For instance, the latch fixation member 166 can move out of the aperture defined by the connector fixation member 168. Because the fixation surface 167 of the latch fixation member 166 is not in alignment with the connector fixation surface 169 along the longitudinal direction L when the latch 140 is in the second configuration, the latch 140 no longer prevents or limits relative movement of the first electrical connector 100 in the second direction with respect to the second electrical connector 104. The first electrical connector 100 can then be unmated and removed from the second electrical connector 104. Therefore, the first electrical connector 100 can be unlatched from the second electrical connector when the disengagement force is applied to the housing body 106. Further, the first electrical connector 100 can be unlatched from the second electrical connector 104 when the disengagement force is applied to the cables 144, which then communicates the force to the housing body 106.

It can become desirable to again mate the first electrical connector 100, or a different electrical connector as described above with respect to the first electrical connector 100, with the second electrical connector 104. In this instance, the electrical connector can be driven in the first or mating direction until the first housing body 106 is inserted in, received by, or otherwise engages the connector housing 109 of the second electrical connector 104, such as when the second electrical conductors 115 mate with the electrical conductors 121 of the second electrical connector 104. The second latch arm 144 of the latch 140 can be urged to flex in the disengagement direction by the connector housing 109 of the second electrical connector 104 during mating. In particular, the angled lip 210 (see FIG. 9) of the second connector housing 109 can move the latch 140 from the first configuration to the second configuration as the first housing body 106 moves in the first direction so as to position the second housing body 128 within the hollow 208. The first electrical connector 100 is mated with the second electrical connector 104 until the latch fixation member 166 becomes aligned with the complementary connector fixation member 168. The second latch arm 144 then flexes out to the first configuration under a natural biasing force of the latch 140 until the latch fixation member 166 engages the connector fixation member 168 in the manner described above.

The latch 140 can include a limiter 174 configured to limit movement of the second latch arm 144 in the disengagement direction. The limiter 174 can be configured to limit movement of the second latch arm 144 towards the first latch arm 142, for instance in the select direction. The limiter 174 can be configured as a tab that projects inward from the second latch arm 144 toward the first latch arm 142. The limiter 174 can have a width in the third direction that is greater than a width of an adjacent portion of the second latch arm 144, or can have any suitable alternative width as desired. The limiter 174 can be extended from the latch actuation body 165, for example. The limiter 174 can include a first limiter 174 and a second limiter 175. The first limiter 174 can be spaced from the second limiter 175 in the third direction. The limiter 174 can be configured to engage a base limiter.

The limiter 174 can engage the second housing body 128 when the latch 140 is in the first configuration. The limiter 174 can move toward the first latch arm 142 as the latch 140 moves to the second configuration. The limiter 174 can contact the first latch arm 142 in order to limit the amount that the latch 140 flexes as it moves to the second configuration. The latch arms 142 and 144 can be touch safe as described in UL Standard 1977 Section 10.2, even though the latches 140 are not energized. In particular, a user's finger is unable to access the latch 140. For instance, the actuator 172 can be disposed outboard of the latch 140 particularly at the first side of the panel 105. Thus, the actuator 172 provides a physical barrier to access of the latch 140. To the extent that a gap may exist between the panel 105 and the actuator 172, the gap can be greater than zero but less than substantially 5 mm, such as greater than zero millimeters but less than substantially 4 mm, such as greater than zero millimeters but less than substantially 3 mm, such as greater than zero millimeters but less than substantially 2 mm, such as greater than zero millimeters but less than substantially 1 mm.

Referring now also to FIG. 2, it should be appreciated that the first electrical connector 100 can include any number of actuators 172 and latches 140 as desired that are constructed as described above and configured to operate in the manner described above. In one example, a second actuator 372 and a second latch 340 can be supported to a second side of the first electrical connector 100 that is opposite of first side of the first electrical connector 100 that supports the first actuator 172 and latch 140. The second latch 340 and second actuator 372 are illustrated having like elements with respect to the first actuator 172 and the first latch 140, and can be configured as described herein with respect to the first actuator 172 and the first latch 140.

Referring to FIG. 1A, the first electrical connector 100 can have a compact design that allows multiple connectors to be coupled to the substrate 102 in a small area. At least one actuator such as the first and second actuators 172 and 372 can allow the first electrical connector 100 to disengage from the second electrical connector 104 without the need to position a tool or one's fingers between adjacent electrical connectors 100. Therefore, the first and second latches 140 and 340, and in particular the respective latch arms 142 and 144 are configured to not be touched by a user or by an external tool to iterate the respective latches from the first configuration to the second configuration when the electrical connectors 100 and 104 are mated to each other.

Referring to FIG. 14, The first electrical connector 100 can have a thickness D1 in the transverse direction T. In one example, the thickness is about 23 millimeters. The thickness D1 can be the distance between the first edge 192 of the first actuator 172 and the first surface 392 of the second actuator 372. A distance D2 between the central axis A₁ of the first connector 100 to the central axis A₅ of a second connector 500 can be about 1 millimeter greater than the thickness D1. The distance D2 can be greater than the thickness D1 by about 0.5 millimeters to about 1 millimeter, about 1 millimeter to about 2 millimeters, about 2 millimeters to about 4 millimeters, about 4 millimeters to about 7 millimeters, or about 7 millimeters to about 10 millimeters. Further, the first connector 100 can be disposed with respect to the second connector 500 such that adjacent actuators between the first connector 100 and the second connector 500 do not contact one another regardless of the latch configuration (e.g., a first configuration, a second configuration, a transition between the two, and the like).

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

When values are expressed as approximations by use of the antecedent “about” it will be understood that the particular value forms another embodiment. In general, use of the term “about” indicates approximations that can vary depending on the desired properties sought to be obtained by the disclosed subject matter and is to be interpreted in the specific context in which it is used, based on its function, and the person skilled in the art will be able to interpret it as such. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, reference to values stated in ranges includes each and every value within that range.

Throughout this specification, words are to be afforded their normal meaning as would be understood by those skilled in the relevant art. However, so as to avoid misunderstanding, the meanings of certain terms will be specifically defined or clarified.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention. Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

1. A communication assembly comprising:
a first device having a housing body and an actuator supported by the housing body; and
a latch supported by the housing body and configured to engage a second device in a first configuration so as to prevent the first and second devices from unmating, wherein the actuator is configured to urge the latch to a second configuration whereby the latch becomes disengaged from the second device.

2. The communication assembly of claim 1, wherein the first device comprises a first data communication device having data communication members supported by the housing body, and the second device comprises a second data communication device.

3. The communication assembly of claim 1, wherein the latch is captured by the second device.

4. The communication assembly of claim 1, wherein the latch resiliently flexes between the first configuration and the second configuration.

5. The communication assembly of claim 1, wherein the first device moves in a first direction so as to mate with the second device, and moves in a second direction so as to separate from the second device.

6. The communication assembly of claim 5, wherein the first direction is opposite the second direction.

7. The communication assembly of claim 1, further comprising an anchor element fixed to the second device.

8. The communication assembly of claim 7, wherein the second device is configured to be mounted to a substrate via the anchor element, such that the first device is in communication with the substrate when the first and second devices are mated to each other.

9. The communication assembly of claim 2, wherein the data communication members comprise electrical conductors.

10. The communication assembly of claim 1, wherein the latch comprises a first fixation member, and the second device comprises a second fixation member, wherein one of the first fixation member and the second fixation member is a projection that is configured to be received in an aperture in the other of the first fixation member and the second fixation member when the latch is in the first configuration.

11. The communication assembly of claim 10, wherein the first fixation member is detachably coupled to the second fixation member.

12. The communication assembly of claim 11, wherein the actuator is configured to urge the first fixation member to decouple from the second fixation member.

13. The communication assembly of claim 5, wherein movement of the first device in the second direction causes the actuator to move from a first position to a second position, which causes the actuator to urge the latch to move to the second configuration.

14. The communication assembly of claim 13, wherein the actuator comprises an actuator head and at least one flexible arm that extends from the actuator head to the housing body, wherein the flexible arm flexes as the first device is urged to move in the second direction, which causes the actuator head to move from the first position to the second position, and the actuator head bears against the latch to move the latch from the first configuration to the second configuration.

15. The communication assembly of claim 14, wherein the at least one flexible arm comprises first and second flexible arms spaced from each other so as to define an opening.

16. The communication assembly of claim 15, wherein a portion of the latch extends through the opening.

17. The communication assembly of claim 14, wherein the actuator head angulates as the actuator moves from the first position to the second position.

18. The communication assembly of claim 17, wherein the actuator comprises a static bearing surface and a dynamic bearing surface, wherein the latch further comprises a latch engagement member, and wherein the static bearing surface is seated against the latch engagement member when the actuator is in the first position, and the dynamic bearing surface rides along the latch engagement member as the actuator moves to the second position.

19. The communication assembly of claim 18, wherein the latch further comprises an engagement surface, wherein the dynamic bearing surface is curved and engage a latch engagement surface of the latch engagement member as the actuator moves from the first position to the second position.

20. The communication assembly of claim 18, wherein the latch further comprises a first latch portion that includes the latch engagement member, and a second latch arm that includes a first fixation member.

21. The communication assembly of claim 20, wherein the actuator is configured to engage a free end of the latch so as to move the latch from the first configuration to the second configuration.

22. The communication assembly of claim 1, wherein first device further comprises a second housing body, and the latch is secured to the housing body of the first device and the second housing body.

23. The communication assembly of claim 22, wherein the latch is captured between the housing body of the first device and the second housing body with respect to movement in first and second directions, wherein the first device moves in a first direction so as to mate with the second device, and moves in a second direction so as to separate from the second device

24. The communication assembly of claim 23, wherein the latch permits limited movement of the housing body of the first device away from the second housing body in the second direction.

25. The communication assembly of claim 24, wherein movement of the housing body of the first device away from the second housing body causes the actuator to bias the latch to the second configuration.

26. The communication assembly of claim 5, wherein the first and second directions are oriented along a longitudinal direction, and at least a portion of the actuator is configured to move in a select direction perpendicular to the longitudinal direction to urge the latch from the first configuration to the second configuration.

27. The communication assembly of claim 1, wherein the first and second devices comprises first and second data communication devices, respectively.

28. The communication assembly of claim 27, wherein the first and second data communication devices comprise electrical connectors, such that the data communication members are respective electrical conductors.

29. The communication assembly of claim 27, wherein at least one of the first and second data communication devices comprises an optical transceiver.

30. A communication assembly comprising:
a first electrical connector comprising:
a first connector portion including an electrically insulative first housing body and a plurality of first electrical conductors supported by the first housing body;
a second connector portion including an electrically insulative second housing body and a plurality of second electrical conductors supported by the second housing body; and
a latch secured to the first and second housing bodies, wherein the latch is movable between a first configuration that locks the first electrical connector to a mated second electrical connector, and a second configuration the unlocks the first electrical connector from the second electrical connector.

31. The communication assembly of claim 30, wherein the latch is captured between the first and second housing bodies.

32. The communication assembly of claim 30, wherein the latch comprises a first latch arm that is secured to the first and second housing bodies, and the latch further comprises a second latch arm that carries a fixation member that is configured to engage the second electrical connector in the first configuration so as to lock the second electrical connector to the first electrical connector.

33. The communication assembly of claim 30, wherein the latch comprises a hinge that extends from the first latch arm and to the second latch arm.

34. The communication assembly of claim 33, wherein the hinge resiliently flexes between the first and second configurations.

35. The communication assembly of claim 30, wherein the first electrical connector comprises an actuator that is configured to urge the latch to move from the first configuration to the second configuration.

36. The communication assembly of claim 35, wherein the first connector portion is movable away from the second connector portion, which causes the actuator to urge the latch to move from the first configuration to the second configuration.

37. The communication assembly of claim 35, wherein the actuator comprises an arm that extends from the first housing body, and movement of the first connector portion away from the second connector portion causes the arm to flex, thereby moving the actuator from a first position to a second position that causes the actuator to urge the latch to move from the first configuration to the second configuration.

38. The communication assembly of claim 30, further comprising the second electrical connector.

39. A communication assembly comprising:
a first device having a housing body and data communication members supported by the housing body;
latching means, supported by the housing body, for engaging a second device in a first configuration so as to prevent the first and second devices from unmating; and
actuating means, supported by the housing body, for urging the latching means to a second configuration whereby the latching means becomes disengaged from the second device.

40. The communication assembly of claim 39, wherein the latching means is captured by the second device.

41. The communication assembly of claim 39, wherein the latching means resiliently flexes between the first configuration and the second configuration.

42. The communication assembly of claim 39, wherein the first device moves in a first direction so as to mate with the second device, and moves in a second direction so as to separate from the second device.

43. The communication assembly of claim 42, wherein the first direction is opposite the second direction.

44. The communication assembly of claim 39, further comprising an anchoring means fixed to the second device.

45. The communication assembly of claim 44, wherein the second device is configured to be mounted to a substrate via the anchor means, such that the first device is in communication with the substrate when the first and second devices are mated to each other.

46. The communication assembly of claim 39, wherein the first and second devices comprise electrical conductors.

47. The communication assembly of claim 39, wherein the second device comprises fixing means for coupling with the latching means of the first device when the latching means is in the first configuration.

48. The communication assembly of claim 47, wherein the latching means is detachably coupled to the fixing means.

49. The communication assembly of claim 47, wherein the actuating means is configured for urging the latching means to decouple from the fixing means.

50. The communication assembly of claim 49, wherein movement of the first device in a second direction causes the actuator to move from a first position to a second position, which causes the actuating means to urge the latching means to move to the second configuration, wherein the first device moves in a first direction so as to mate with the second device, and moves in the second direction so as to separate from the second device.

51. The communication assembly of claim 50, wherein the latching means is captured between the housing body of the first device and the second housing body with respect to movement in the first and second directions.

52. The communication assembly of claim 50, wherein the latch mean permits limited movement of the housing body of the first device away from the second housing body in the second direction.
